(19) United States
(12) Patent Application Publication
(10) Pub. No.: US 2017/0293833 A1
(43) Pub. Date: Oct. 12, 2017

(54) SMART CARD AND METHOD FOR PRODUCING A SMART CARD

(71) Applicant: Infineon Technologies AG

(72) Inventors: Jens POHL, Bernhardswald (DE); Frank PUESCHNER, Kelheim (DE)

(21) Appl. No.: 15/482,865

(22) Filed: Apr. 10, 2017

(30) Foreign Application Priority Data
Apr. 12, 2016 (DE) 10 2016 106 698

(51) Int. Cl. G06K 19/077; G06K 19/07

(52) U.S. Cl. CPC G06K 19/07775; G06K 19/0723; G06K 19/07749; G06K 19/07722

(57) ABSTRACT

In various embodiments, a smart card is provided. The smart card includes a smart card body having a first depression for accommodating a chip carrier and having a second depression in the first depression for accommodating a chip that is arranged on the chip carrier, and a booster antenna structure having a chip coupling region for inductive coupling to the chip. The chip coupling region includes a plurality of coupling turns. The chip coupling region is embedded in the smart card body. The bottom of the second depression is arranged in the smart card body less deeply than the highest region of the coupling turns which faces the second depression.

### CROSS-REFERENCE TO RELATED APPLICATION

This application claims priority to German Patent Application Serial No. 10 2016 106 698.2, which was filed Apr. 12, 2016, and is incorporated herein by reference in its entirety.

### TECHNICAL FIELD

Various embodiments relate generally to a smart card and to a method for producing a smart card.

### BACKGROUND

Smart cards are often used as contactless smart cards, or as smart cards which enable both a contactless and a contact-based data exchange with a base station outside the smart card.

In both cases a so-called semiconductor module (also referred to as a smart card module) can be used which may include a chip carrier, e.g. a chip carrier substrate, on which a chip can be mounted, in conjunction with a smart card body, in which an antenna (also referred to as a booster antenna) can be arranged.

FIG. 1 illustrates a typical smart card module 100.

The smart card module 100 may include a contact side 102 for contact-based operation, which can also be referred to as an ISO side because a plurality of contacts 112 arranged on the contact side 102 are typically configured in accordance with the specifications of ISO 7816-2.

Furthermore, the smart card module 100 may include a chip carrier 116, which usually includes a polymer, for example polyethylene terephthalate (PET), polyimide (PI) or a laminate material.

The smart card module 100 may furthermore include a chip 110. The chip 110 can be mounted as a so-called “flip chip” (i.e. turned over such that contacts of the chip 110 point toward the chip carrier 116) (accordingly, this technology is also referred to as “flip chip on substrate” (FCOS®)). The chip 110 can be mounted on a second side 104 of the smart card module 100. The second side 104 can accordingly also be referred to as a chip side 104.

The smart card module 100 can be formed as a so-called COM module. That means that an antenna 106 (also referred to as a module antenna 106) connected to the chip 110 is arranged on the chip carrier 116, for transmitting and receiving electrical signals by means of inductive coupling to a so-called booster antenna. Such a smart card module 100 is also referred to as a “coil-on-module” module or COM module.

A booster antenna 222 is illustrated in FIG. 2, as booster antenna 222 embedded into a smart card body 220.

In the case of the smart card module 100, connections between terminals on the chip side and terminals on the ISO side can be produced by means of vias, e.g. by means of openings having conductive coatings, so-called “plated through holes” (PTHs).

The smart card module (COM module) 100 can be arranged in the smart card body 220 with the booster antenna 222 from FIG. 2 and thus form a smart card for contact-based and contactless data exchange (on the basis of the English term “dual interface”, such a smart card is correspondingly also referred to as a DIF smart card).

Such DIF smart cards are used for example for applications in the field of local public transport, identification or banking.

For mounting the smart card module 100 as part of a smart card, for example embedding the smart card module 100 into the smart card body 220 in a region 226, it is possible to provide a two-step depression in the smart card body 220, e.g. by means of milling.

As is illustrated in FIG. 3 (bottom), the entire smart card module 100 can be arranged in a first depression 330.

The chip 110 (e.g. the chip 110 mounted as flip-chip) can be arranged in a deeper second depression 226.

The booster antenna 222 can usually be arranged approximately centrally in the approximately 760 μm thick smart card (or the equally thick smart card body 220), in order to avoid a mechanical imbalance and warpage of the smart card.

With the use of a DIF module 100, in this case the second depression 226 is typically deeper than a vertical position of the embedded booster antenna 222. In FIG. 3 this can be discerned from the fact that a depth 226t of the second depression 226, as measured from a first surface 220s1 of the smart card body 220, is greater than a distance 224h between a plane that connects surfaces—facing the first surface 220s1—of a chip coupling region 224 of the booster antenna 222 and the surface 220s1.

Since the second depression 226 projects from the surface 220s1 beyond the plane of the booster antenna 222, or its chip coupling region 224, the chip coupling region 224 has to be arranged such that it is not damaged during a process of forming, e.g. milling, the second depression 226. In addition to a width of the second depression 226 that is required for arranging the chip 110 in the second depression 226, it is necessary to provide a safety region in order to take account of manufacturing tolerances (e.g. a positioning tolerance of the booster antenna 222 or its chip coupling region 224 and/or a milling tolerance).

This means that the coupling region 224 of the booster antenna 222 can be arranged at a relatively large lateral distance from a lateral center of the smart card module 100, and only a small lateral overlap between the chip coupling region 224 and the smart card module 100 or the antenna 106 arranged thereon thus results.

To put it another way, an internal diameter of the booster antenna (or of the chip coupling region 224) 224i must be greater than a size (e.g. a diameter) 226b of the second depression 226.

This limitation of the booster antenna geometry (or of the chip coupling region 224) adversely affects a quality of the inductive coupling between the booster antenna 222 (or its chip coupling region 224) and the module antenna 106.

This is because, for a good or optimum inductive coupling, a good overlap of booster antenna 222 (or its chip coupling region 224) and module antenna 106 may be necessary, but cannot be realized owing to the limitation, such that an electrical performance of this design may be limited, e.g. with regard to a minimum field strength Hₘᵢₙ and/or with regard to a data rate VHBR (stands for “very high bit rate”).

There is thus a demand for a smart card in which the above-described geometrical and (resulting therefrom) electrical limitations of the above-described arrangement are eliminated (or at least reduced).

### SUMMARY

In various embodiments, a smart card is provided. The smart card includes a smart card body having a first depression for accommodating a chip carrier and having a second depression in the first depression for accommodating a chip that is arranged on the chip carrier, and a booster antenna structure having a chip coupling region for inductive coupling to the chip. The chip coupling region includes a plurality of coupling turns. The chip coupling region is embedded in the smart card body. The bottom of the second depression is arranged in the smart card body less deeply than the highest region of the coupling turns which faces the second depression.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows schematic illustrations of a top side and of an underside of a conventional chip carrier with a chip and a chip antenna;

FIG. 2 shows a schematic illustration of a conventional smart card including a booster antenna and a depression for embedding a chip carrier;

FIG. 3 shows schematic cross-sectional views of a smart card body with depressions for embedding a chip carrier without chip carrier and chip (top) and with chip carrier and chip (bottom);

FIG. 4 shows schematic cross-sectional views of a smart card body with depressions for embedding a chip carrier without chip carrier and chip (top) and with chip carrier and chip (bottom) in accordance with various embodiments;

FIG. 5 shows schematic illustrations of a chip carrier with a chip and a chip antenna (left) and a chip coupling region of a booster antenna (right) with an illustration of an overlap region of the antennas in accordance with various embodiments;

FIG. 6 shows a flow diagram of a method for producing a smart card in accordance with various embodiments; and

FIG. 7 shows a flow diagram of a method for producing a smart card in accordance with various embodiments.

### DESCRIPTION

In the following detailed description, reference is made to the accompanying drawings, which form part of this description and show for illustration purposes specific embodiments in which the invention can be implemented. In this regard, direction terminology such as, for instance, “at the top”, “at the bottom”, “at the front”, “at the back”, “front”, “rear”, etc. is used with respect to the orientation of the figure(s) described. Since components of embodiments can be positioned in a number of different orientations, the direction terminology serves for illustration and is not restrictive in any way whatsoever. It goes without saying that other embodiments can be used and structural or logical changes can be made, without departing from the scope of protection of the present invention. It goes without saying that the features of the various embodiments described herein can be combined with one another, unless specifically indicated otherwise. Therefore, the following detailed description should not be interpreted in a restrictive sense, and the scope of protection of the present invention is defined by the appended claims.

In the context of this description, the terms “connected” and “coupled” are used to describe both a direct and an indirect connection and a direct or indirect coupling. In the figures, identical or similar elements are provided with identical reference signs, insofar as this is expedient.

In various embodiments, a smart card including an FCOS COM module is provided, said module including a very thin semiconductor chip, i.e. a semiconductor chip having a thickness in a range of approximately 30 μm to approximately 80 μm, which is part of a smart card including an embedded antenna, e.g. a wire antenna, for inductive coupling to the COM module. Experience shows that thin chips having a thickness in this range are flexible enough to withstand breaking under mechanical loading. A feasibility or usability of thin flip-chips has already been demonstrated in association with contactless COM modules.

In various embodiments, for the purpose of embedding a smart card module into a smart card, the depth of the second depression can be less than the distance between the top side of the booster antenna (or the chip coupling region of the booster antenna) and the first surface of the smart card body. A (lateral) overlap between the second depression and the chip coupling region of the booster antenna can be achieved as a result.

In various embodiments, it is possible to use a very thin (e.g. approximately 30 μm to approximately 80 μm thick) flip chip which enables a very shallow second depression which can overlap the chip coupling region of the booster antenna (e.g. laterally). One condition for this may be that a depth of the second depression can be less than a distance between a top side of the smart card and a top side of the chip coupling region of the booster antenna, such that the antenna, e.g. the antenna wire, runs no risk of being damaged during a process of forming (e.g. milling) the second depression.

In various embodiments, it is thus possible to provide a geometry of a chip coupling region which provides a good overlap with a region of the module antenna, which leads to a high quality of the inductive coupling.

In contrast to conventional arrangements, various embodiments can make it possible to choose an electrically optimized configuration of the chip coupling region that is independent of a geometry of the second depression.

In various embodiments, a smart card is provided. The smart card may include: a smart card body having a first depression for accommodating a chip carrier and having a second depression in the first depression for accommodating a chip that is arranged on the chip carrier, and a booster antenna structure having a chip coupling region for inductive coupling to the chip. The chip coupling region may include a plurality of coupling turns. The chip coupling region can be embedded in the smart card body. The bottom of the second depression can be arranged in the smart card body less deeply than the highest region of the coupling turns which faces the second depression.

In various embodiments, the smart card may furthermore include the chip carrier with the chip arranged thereon. The chip carrier can be accommodated in the first depression, and the chip can be accommodated in the second depression.

In various embodiments, the bottom of the second depression can be arranged in the smart card body at a maximum depth of 450 μm from a surface of the smart card body proceeding from which the first depression can be arranged in the smart card body.

In various embodiments, the booster antenna structure can be applied on a carrier film. The highest region of the coupling turns can be the highest point of the chip coupling region of the booster antenna structure.

In various embodiments, a distance between the bottom of the second depression and the highest region of the coupling turns which faces the second depression can be at least 50 μm.

In various embodiments, at least five coupling turns of the plurality of coupling turns can laterally overlap the first depression.

In various embodiments, a smart card is provided. The smart card may include: a smart card body having a first depression for accommodating a chip carrier and having a second depression in the first depression for accommodating a chip that is arranged on the chip carrier. The first depression laterally delimits a chip carrier region. The smart card may further include a booster antenna structure having a chip coupling region for inductive coupling to the chip. The chip coupling region may include a plurality of coupling turns. The chip coupling region can be embedded in the smart card body. At least five coupling turns of the plurality of coupling turns can be arranged laterally within the chip carrier region.

In various embodiments, the chip can have a thickness of 80 μm or less.

In various embodiments, at least one part of the chip coupling region can be arranged between the bottom of the second depression and a second side of the smart card body, said second side being situated opposite a first side of the smart card body having the first and second depressions.

In various embodiments, a method for producing a smart card is provided. The method may include: embedding a booster antenna structure having a chip coupling region for inductive coupling to a chip into a smart card body- The chip coupling region may include a plurality of coupling turns. The method may further include arranging a first depression for accommodating a chip carrier in the smart card body, and arranging a second depression for accommodating a chip that can be arranged on the chip carrier in the first depression. The bottom of the second depression can be arranged in the smart card body less deeply than the highest region of the coupling turns which faces the second depression.

In various embodiments, a method for producing a smart card is provided. The method may include: embedding a booster antenna structure having a chip coupling region for inductive coupling to a chip into a smart card body. The chip coupling region may include a plurality of coupling turns. The method may further include arranging a first depression for accommodating a chip carrier in the smart card body. The first depression can laterally delimit a chip carrier region. The method may further include arranging a second depression for accommodating a chip that can be arranged on the chip carrier in the first depression. At least five coupling turns of the plurality of coupling turns can be arranged laterally within the chip carrier region.

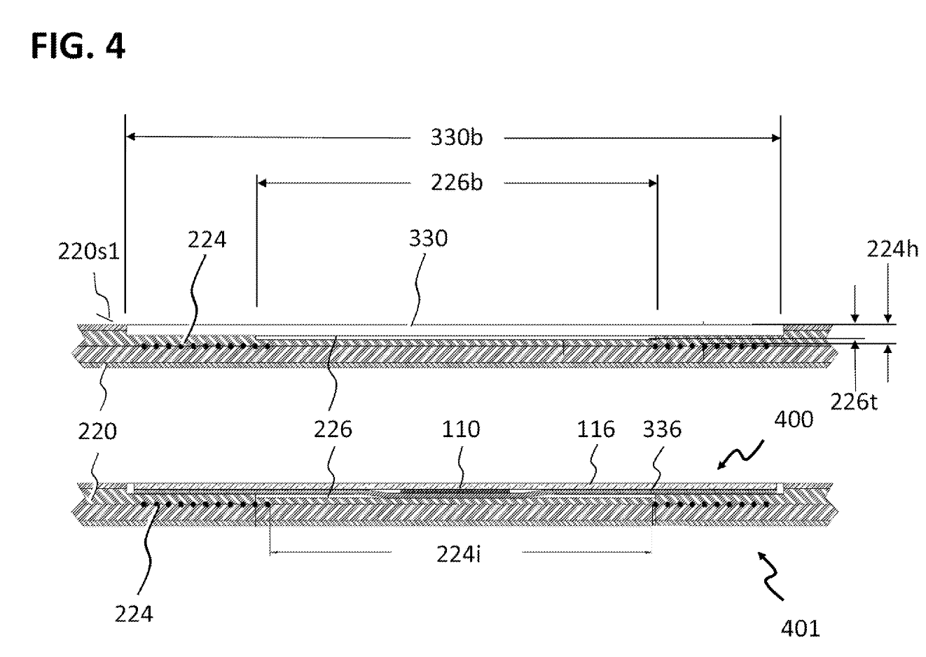

FIG. 4 shows schematic cross-sectional views of a smart card 401 including a smart card body 220 having depressions 226, 230 for embedding a chip carrier 116: without chip carrier 116 and without chip 110 (top) and with chip carrier 116 and chip 110 (bottom) in accordance with various embodiments.

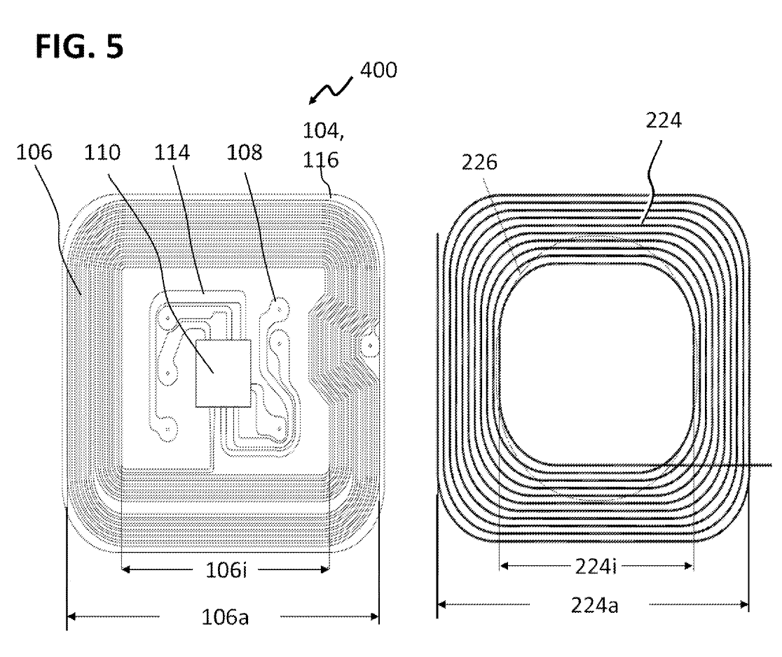

FIG. 5 shows schematic illustrations of a smart card module 400, i.e. of a chip carrier 116 with a chip 110 and a module antenna 106 (left), and a chip coupling region 224 of a booster antenna 222 (right) with an illustration of an overlap region of the antennas 106, 224 in accordance with various embodiments.

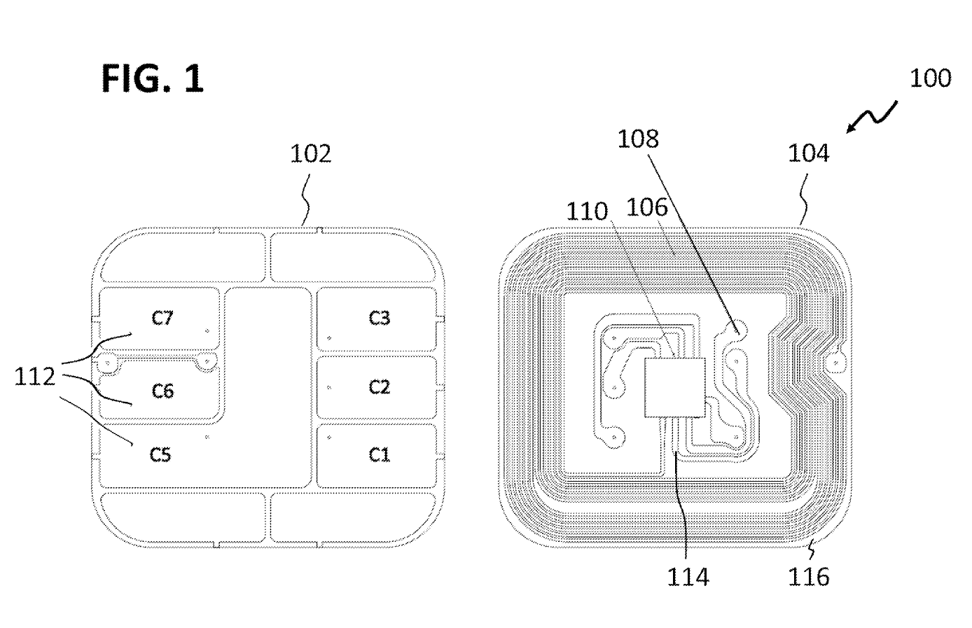

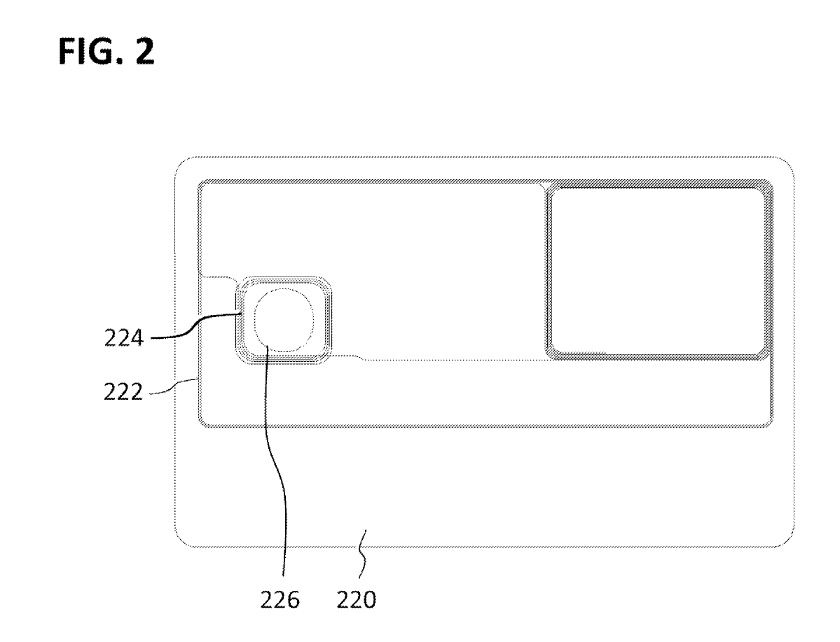

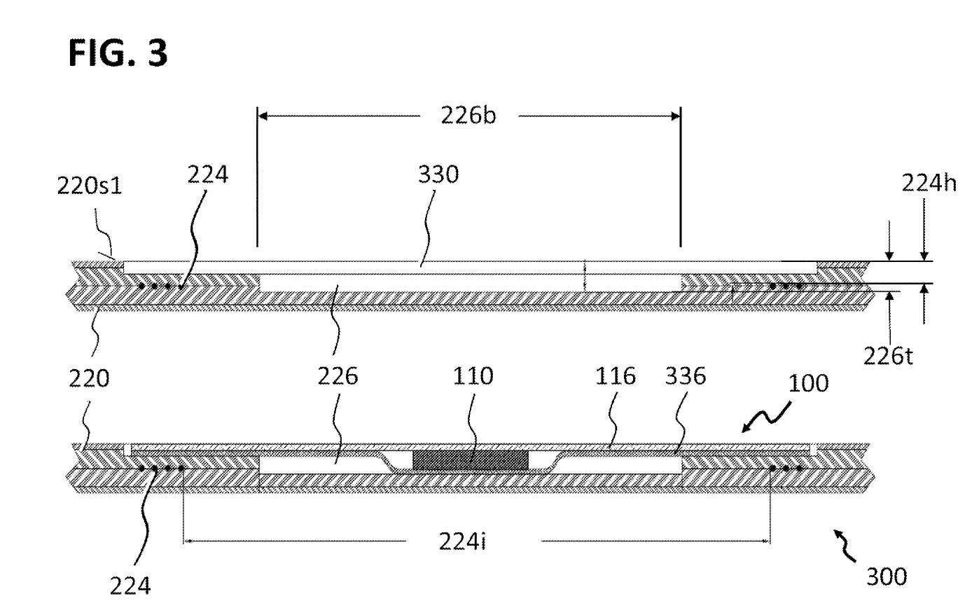

In various embodiments, components, materials, effects, dimensions, distances, etc. of devices or parts thereof which are described in association with FIG. 4 and FIG. 5 may correspond to those described in association with FIGS. 1 to 3. Repetition may therefore be dispensed with, and the components, materials, effects, dimensions distances, etc. may be provided with the same reference signs.

As is illustrated in FIG. 4, in accordance with various embodiments, a first depression 330 having a width 330b can be arranged in a smart card body 220 proceeding from a first surface 220s1 of the smart card body 220.

The first depression 330 can be arranged in the smart card body 220 by means of milling, for example. However, it is also possible to use other known methods for forming openings in the smart card body 220.

In various embodiments, the smart card body 220 may include, as described above, a polymer material, for example PET and/or PI. By way of example, the smart card body 220 can be formed in a multilayered fashion, e.g. may include a laminate material. A thickness of the smart card body 220 can be a typical thickness; the thickness can be approximately 760 μm, for example. The smart card body 220 can have a suitable thickness deviating therefrom.

In various embodiments, a second depression 226 can be arranged within the first depression 330. The second depression 226 can extend for example from a bottom of the first depression 330 in a manner facing away from the first depression 330. The second depression 226 can have a width 226b and a depth 226t. The depth 226t of the second depression 226 can be measured proceeding from the first surface 220s1 of the smart card body 220. The second depression 226 can be arranged in the smart card body 220 by means of milling, for example. However, it is also possible to use other known methods for forming openings in the smart card body 220.

In various embodiments, the first depression 330 can serve for accommodating a chip carrier 116, and the second depression 226 can serve for accommodating a chip 110 arranged on the chip carrier 116. The chip 110 can be mounted as a flip-chip on the chip carrier 116.

The second depression 226 can be arranged for example laterally centrally within the first depression 330. Generally, the second depression 226 can be arranged within the first depression 330 such that the chip 110 mounted on the chip carrier 116, upon arrangement of the chip carrier 116 in the first depression 330, is arranged approximately centrally in the second depression 226.

In various embodiments, the smart card 401 may include a booster antenna 222 (also referred to as a booster antenna structure 222). The booster antenna 222 can for example be arranged, for example embedded, in the smart card body 220.

In various embodiments, the booster antenna structure can be applied on a carrier film.

In various embodiments, the booster antenna 222 may include booster antenna turns composed of metal, for example composed of copper, a copper-nickel alloy, or composed of aluminum, which are arranged in one plane. The booster antenna 222 can be formed such that it includes a chip coupling region 224 formed such that it can inductively couple to a chip 110 arranged laterally within the chip coupling region 224, or to a module antenna 106 which is electrically conductively connected to the chip 110 and which can likewise be arranged within the chip coupling region 224. The chip coupling region 224 may include a plurality of turns, also referred to as coupling turns. The plurality of turns of the chip coupling region 224 can form one plane, which can correspond for example to the plane formed by the booster antenna turns.

In various embodiments, the chip coupling region 224 (or the entire booster antenna 222) can be arranged in the smart card body 220 such that a top side of the plurality of turns of the chip coupling region 224, said top side facing toward the first surface 220s1 of the smart card body 220, is arranged at a distance 224h from the first surface 220s1 of the smart card body 220. In various embodiments, the highest region of the coupling turns can be the highest point of the chip coupling region of the booster antenna structure 222.

In various embodiments, a distance between the bottom of the second depression 226 and the highest region of the coupling turns 224 which faces the second depression 226 can be at least 50 μm. To put it another way, a difference between the distance 224h of the top side of the plurality of turns of the chip coupling region 224 from the first surface 220s1 of the smart card body 220 and the depth 226t of the second depression 226 can be greater than approximately 50 μm, for example approximately 60 μm, for example approximately 70 μm, for example approximately 80 μm.

In various embodiments, the distance between the bottom of the second depression 226 and the highest region of the coupling turns 224 which faces the second depression 226 can form a safety distance in order to ensure that the coupling turns 224 are not damaged during a process of forming the second depression 226, for example during milling.

In various embodiments, the second depression 226 can have a depth 226t that is smaller than the distance 224h between the top side of the plurality of turns of the chip coupling region 224 and the first surface of the smart card body 220.

In various embodiments, this can be made possible by the use of a very thin chip 110, for example having a chip thickness in the range of approximately 30 μm to approximately 80 μm, for example of approximately 50 μm to approximately 70 μm. Together with the chip carrier 116 and an adhesion medium 336, for example a heat-sealable adhesive, which together can have for example a thickness of approximately 100 μm to approximately 160 μm, this can result in a total thickness (at a location at which the chip 110 is situated) for a smart card module 400 to be arranged in the first and second depressions of approximately 250 μm.

In various embodiments, the second depression 226 can have a depth 226t of a maximum of approximately 450 μm, for example a maximum of approximately 350 μm, for example a maximum of approximately 300 μm, for example a maximum of approximately 250 μm.

Even with a maximum depth of more than approximately 350 μm, for example, in various embodiments, the depth 226t of the second depression 226 can, however, still be less than the distance 224h between the top side—facing toward the first surface 220s1 of the smart card body 220—of the plurality of turns of the chip coupling region 224 and the first surface 220s1 of the smart card body 220. In that case, it is possible for example to arrange the booster antenna 222 with the chip coupling region 224 further away from the first surface 220s1 of the smart card body 220 than vertically centrally in the smart card body 220. In such a case, it is also possible, for example, to use a chip 110 that is thicker than the very thin chip 110, for example a chip 110 having a conventional thickness, for example having a thickness of up to approximately 300 μm or even up to approximately 330 μm.

Since the second depression 226 has a smaller depth 226t than the distance 224h between the top side—facing toward the first surface 220s1 of the smart card body 220—of the plurality of turns of the chip coupling region 224 and the first surface 220s1 of the smart card body 220, what can be achieved in various embodiments is that a lateral safety distance between a width 226b of the second depression 226 and an internal diameter 224i of the coupling turns 224 can be dispensed with, that is to say that the coupling turns 224 can be arranged independently of the second depression 226.

In various embodiments, a lateral chip carrier region can be defined by the first depression 330. Owing to the lack of limitation of the configuration of the chip coupling region 224 by virtue of the second depression 226, a plurality of the coupling turns of the chip coupling region 224, for example at least five turns (e.g. at least six, seven, eight, nine, ten, eleven, twelve, or more turns), can be arranged laterally in the chip carrier region.

In various embodiments, the module antenna 106 can be arranged on the chip carrier 116, which may have to be arranged within the first depression 330. The module antenna 106 may include a plurality of module antenna turns.

Owing to an arrangement of the for example at least five coupling turns in the chip carrier region, in comparison with the overlap of a maximum of three to four turns that is allowed by a conventional configuration, a high overlap of coupling turns and module antenna turns can result. This can for example make possible a high data transmission rate, whilst simultaneously complying with further specifications, and/or make possible the use of lower response field strengths. In this case, e.g. an arrangement of eight or more coupling turns in the chip carrier region can entail a significant improvement in performance (e.g. with regard to data transmission rate and/or response field strength).

FIG. 5 illustrates the smart card module 400 (left, as a schematic plan view of the second side 104 of the chip carrier 116, on which side the chip 110 and the module antenna 106 are arranged) and a schematic plan view of the chip coupling region 224 of the booster antenna 222 (right) in accordance with various embodiments on the same size scale for comparison purposes.

It can be discerned in this comparison that vertically arranging the smart card module 400 above the chip coupling region 224, which can be carried out in various embodiments, if the smart card module 400 is arranged in the first depression 330 such that the chip 110 is accommodated in the second depression 226 (in this respect, also see FIG. 4), can lead to a large overlap of the areas which are covered by the chip coupling region 224 of the booster antenna 222 and respectively by the module antenna 106, in other words to a large lateral overlap between the module antenna 106 and the chip coupling region 224 of the booster antenna, which can entail the abovementioned advantages, e.g. with regard to data transmission rate and/or response field strength.

In the case of the conventional smart card, not only should that region of the second depression which is marked by 226 in the right-hand schematic drawing have remained free of the turns of the chip coupling region 224, but on top of that a safety distance should also have been complied with, such that only approximately the three outermost turns of the chip coupling region 224 could have been implemented.

In various embodiments, at least part of the chip coupling region 224, for example at least one turn of the coupling turns, can be arranged between the bottom of the second depression 226 (which can be situated at a distance 226t from the first surface 220s1) and a second side of the smart card body 220, said second side being situated opposite the first side of the smart card body 220, said first side having the first depression 226 and the second depression 330 (and for example also the first surface 220s1). This can bring about the above-described overlap between the coupling turns and the module antenna turns with the resultant advantages described above.

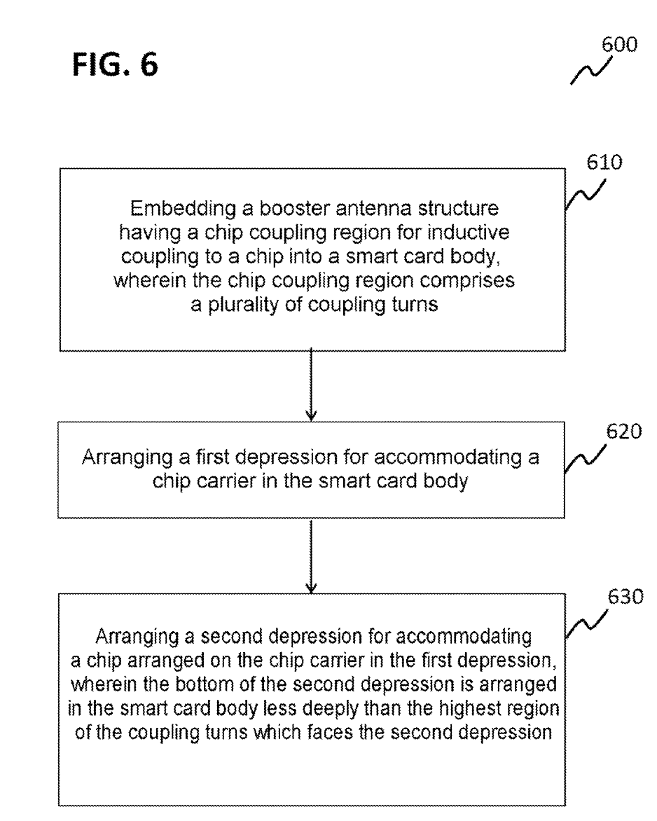

FIG. 6 shows a flow diagram 600 of a method for producing a smart card in accordance with various embodiments.

In various embodiments, the method may include: embedding a booster antenna structure having a chip coupling region for inductive coupling to a chip into a smart card body, wherein the chip coupling region includes a plurality of coupling turns (in 610), arranging a first depression for accommodating a chip carrier in the smart card body (in 620), and arranging a second depression for accommodating a chip arranged on the chip carrier in the first depression, wherein the bottom of the second depression is arranged in the smart card body less deeply than the highest region of the coupling turns which faces the second depression (in 630).

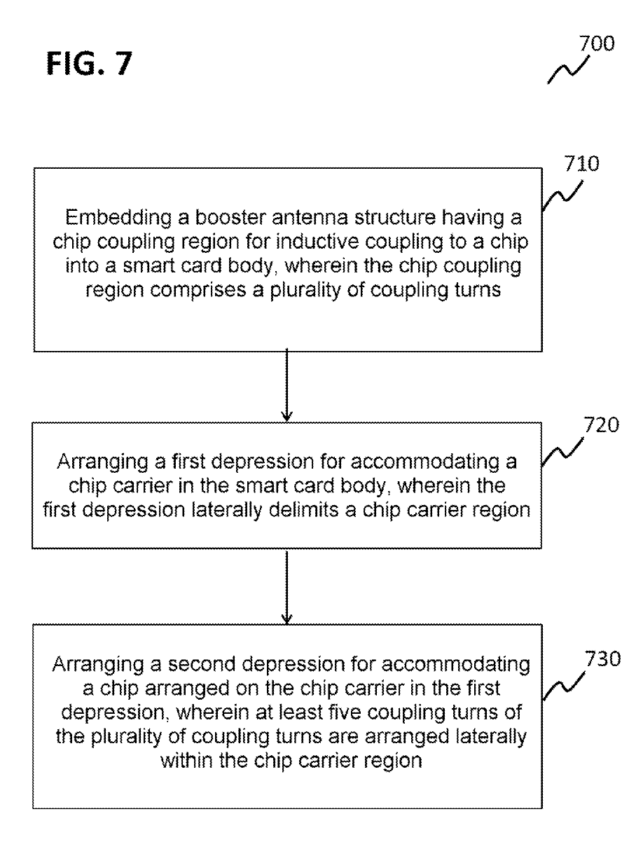

FIG. 7 shows a flow diagram 700 of a method for producing a smart card in accordance with various embodiments.

In various embodiments, the method may include: embedding a booster antenna structure having a chip coupling region for inductive coupling to a chip into a smart card body, wherein the chip coupling region includes a plurality of coupling turns (in 710), arranging a first depression for accommodating a chip carrier in the smart card body (in 720), and arranging a second depression for accommodating a chip arranged on the chip carrier in the first depression, wherein at least five coupling turns of the plurality of coupling turns are arranged laterally within the chip carrier region (in 730).

Further advantageous configurations of the method are evident from the description of the device, and vice versa.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A smart card, comprising:
a smart card body having a first depression for accommodating a chip carrier and having a second depression in the first depression for accommodating a chip that is arranged on the chip carrier; and
a booster antenna structure having a chip coupling region for inductive coupling to the chip, wherein the chip coupling region comprises a plurality of coupling turns, wherein the chip coupling region is embedded in the smart card body;
wherein a bottom of the second depression is arranged in the smart card body less deeply than a highest region of the coupling turns which faces the second depression.

2. The smart card of claim 1, further comprising:
the chip carrier with the chip arranged thereon;
wherein the chip carrier is accommodated in the first depression; and
wherein the chip is accommodated in the second depression.

3. The smart card of claim 1,
wherein the bottom of the second depression is arranged in the smart card body at a maximum depth of 450 μm from a surface of the smart card body proceeding from which the first depression is arranged in the smart card body.

4. The smart card of claim 1,
wherein the booster antenna structure is applied on a carrier film; and
wherein the highest region of the coupling turns is the highest point of the chip coupling region of the booster antenna structure.

5. The smart card of claim 1,
wherein a distance between the bottom of the second depression and the highest region of the coupling turns which faces the second depression is at least 50 μm.

6. The smart card of claim 1,
wherein at least five coupling turns of the plurality of coupling turns laterally overlap the first depression.

7. The smart card of claim 1, wherein the chip has a thickness of 80 μm or less.

8. The smart card of claim 1,
wherein at least one part of the chip coupling region is arranged between the bottom of the second depression and a second side of the smart card body, said second side being situated opposite a first side of the smart card body having the first and second depressions.

9. A smart card, comprising:
a smart card body having a first depression for accommodating a chip carrier and having a second depression in the first depression for accommodating a chip that is arranged on the chip carrier, wherein the first depression laterally delimits a chip carrier region; and
a booster antenna structure having a chip coupling region for inductive coupling to the chip, wherein the chip coupling region comprises a plurality of coupling turns, wherein the chip coupling region is embedded in the smart card body, wherein at least five coupling turns of the plurality of coupling turns are arranged laterally within the chip carrier region.

10. The smart card of claim 9,
wherein the chip has a thickness of 80 μm or less.

11. The smart card of claim 9,
wherein at least one part of the chip coupling region is arranged between a bottom of the second depression and a second side of the smart card body, said second side being situated opposite a first side of the smart card body having the first and second depressions.

12. A method for producing a smart card, the method comprising:
embedding a booster antenna structure having a chip coupling region for inductive coupling to a chip into a smart card body, wherein the chip coupling region comprises a plurality of coupling turns;
arranging a first depression for accommodating a chip carrier in the smart card body; and
arranging a second depression for accommodating a chip arranged on the chip carrier in the first depression;
wherein a bottom of the second depression is arranged in the smart card body less deeply than a highest region of the coupling turns which faces the second depression.

13. The method of claim 12,
wherein the chip is arranged on the chip carrier;
wherein the chip carrier is accommodated in the first depression; and
wherein the chip is accommodated in the second depression.

14. The method of claim 12,
wherein the bottom of the second depression is arranged in the smart card body at a maximum depth of 450 μm from a surface of the smart card body proceeding from which the first depression is arranged in the smart card body.

15. The method of claim 12,
wherein a distance between the bottom of the second depression and the highest region of the coupling turns which faces the second depression is at least 50 μm.

16. A method for producing a smart card, the method comprising:
embedding a booster antenna structure having a chip coupling region for inductive coupling to a chip into a smart card body, wherein the chip coupling region comprises a plurality of coupling turns;
arranging a first depression for accommodating a chip carrier in the smart card body, wherein the first depression laterally delimits a chip carrier region; and
arranging a second depression for accommodating a chip arranged on the chip carrier in the first depression;
wherein at least five coupling turns of the plurality of coupling turns are arranged laterally within the chip carrier region.

17. The method of claim 16,
wherein the chip is arranged on the chip carrier;
wherein the chip carrier is accommodated in the first depression; and
wherein the chip is accommodated in the second depression.

18. The method of claim 16,
wherein the chip has a thickness of 80 μm or less.

19. The method of claim 16,
wherein at least one part of the chip coupling region is arranged between a bottom of the second depression and a second side of the smart card body, said second side being situated opposite a first side of the smart card body having the first and second depressions.

20. The method of claim 16,
wherein the chip has a thickness of 80 μm or less.
